(19) United States
(12) Patent Application Publication
(10) Pub. No.: US 2004/0143570 A1
(43) Pub. Date: Jul. 22, 2004

(54) Strategy based search

(76) Inventors: Brian Klock, Forked River, NJ (US); David Berton, Bordentown, NJ (US); Eric J. Glover, North Brunswick, NJ (US); Steven Kordik, Hamilton, NJ (US)

Correspondence Address: TRAN & ASSOCIATES, 6768 MEADOW VISTA CT., SAN JOSE, CA, 95135, US

(21) Appl. No.: 10/677,779

(22) Filed: Oct. 1, 2003

Related U.S. Application Data
(60) Provisional application No. 60/441,404, filed on Jan. 21, 2003.

(51) Int. Cl. G06F 7/00

(52) U.S. Cl. 707/3

(57) ABSTRACT

A search system has a plurality of resources, including data resources and query and result processing resources. The search system determines the selection and ordering of resources at run-time through a combination of pre-defined default rules and a search strategy that is associated with each search.

This application claims the benefit of U.S. Provisional Application 60/441,404 filed Jan. 21, 2003, the content of which is hereby incorporated-by-reference.

### BACKGROUND

The present invention relates generally to strategy-based searching.

Information retrieval is the process of finding relevant results for a given information need. Typically a search system has several types of resources that are pooled together to answer a search request. Search resources include data sources as well as query and result processing modules and associated algorithms. In typical search systems the specific set of resources utilized for a given query is fixed, and operates in a fixed manner. In some systems, options can vary the specific decisions using hard-coded rules (such as choosing a particular database based on the query words). The approach of using a fixed set of resources in a predetermined manner limits the ability to incorporate expertise into a search.

Conventional approaches do not provide the ability to specify arbitrary high-level search strategies that provide not only for federated searching (i.e., the ability to search over one or more remote search engines), but also for designating how to search each remote search engine, and for seamlessly integrating a plurality of resources or modules to modify the query (thesaurus, spell checker, etcetera), and for seamlessly integrating a plurality of resources or modules to modify the result of the searching (result scoring, etcetera) for display to the user, for example.

### SUMMARY

In one aspect, information is searched in a search system having a plurality of resources and production rules for using, ordering and/or manipulating those resources. The search system augments the production rules based on a search strategy; and dynamically determines at run-time the selection and order of said resources according to the default production rules along with the augmented production rules.

Implementations of the above aspect may include one or more of the following. The augmenting of the system's production rules can nullify or can place additional constraints on the production rules at run-time. The search strategy can be specified at run-time. The search strategy can be specified by a user or can be hard-coded (programmed in advance). The search strategy can be implemented over a plurality of search passes. The system state can be communicated through a query. The system state can also be communicated in one or more messages passed among the resources. The search strategy includes conditional operators that are evaluated during the search. The resource includes query processing resources, result processing resources and data sources, among others. Each resource can be controlled in accordance with the search strategy the system state, and the default rules. The augmenting of the production rules can be done by modifying a query message, wherein the modifying further comprises adding, deleting or changing of one or more keys. The augmenting of the production rules can also be done by modifying a data request, wherein the modifying further comprises adding, deleting or changing of one or more keys. Other ways to augment the production rules include adding a data request (the adding of the of the data request does not alter the production rules); altering a route or altering the resource selection process; locally routing the messages or objects to enforce a modified ordering; answering or generating one or more control messages, which are data that a strategy can be condition on; updating a next pass condition to communicate the need for another pass by the strategy query processor. The system can also optimize a search result given the strategy and the default production rules.

Advantages of the invention may include one or more of the following. The system can operate in a federated search system with multiple data sources as well as regular search systems. The system provides the ability to specify high-level search strategies that provide not only for federated searching (i.e., the ability to search over one or more remote search engines), but also for designating how to search each remote search engine, and for seamlessly integrating a plurality of modules to modify the query (thesaurus, spell checker, etcetera), and for seamlessly integrating a plurality of modules to modify the result of the searching (result scoring, etcetera) for display to the user, for example.

The system searches in accordance with “high-level strategies”, or simple combinations of conditional tasks to search local and remote resources. The system's strategic searching is more powerful than simple keyword searching, and is more flexible than rigid programming since strategies can be partially specified, as opposed to requiring a complete program. Strategies only influence parts of the decision making process, and areas unaffected behave in the default manner. Strategy-based searches can be modularized and are flexible. The control of the modules is dynamic (per search) and does not require extensive knowledge of each module involved in a given search.

The system advantageously applies intelligent search strategies and intelligent result processing to be customizable for different user needs. In general, the search plan is a specification of what informational source or sources to search, and how to search each source. Unlike typical federated searching, it is not always desirable to send an unmodified user query to all possible informational sources. Likewise, the decision of how to search a particular informational source may be a function of a search query and other parameters. That is, a user may wish to include a thesaurus for a particular search and the high-level search strategy may accommodate this by incorporating a thesaurus such that the user's query is augmented with synonyms. Or, a heavily loaded system should probably skip the slow informational sources (e.g., remote databases), but only if there is sufficient coverage for the user's need. Thus, for example, it is desirable to enable the search system to produce a high-level search plan that searches all informational sources when the search system is not busy, but when the search system is handling many user search requests, the search plan accounts for this by excluding the slower information sources. Each search applies appropriate local-knowledge and expertise, and only searches the desirable informational collections. The local knowledge can help to both select appropriate informational sources, as well as permit specialized searches on general-purpose databases, e.g., the World Wide Web or the enterprise's main website. Additionally, the search system is adaptable, such that adding new search algorithms, informational collections (i.e., databases or resources) or new user-types requires minimal or no changes to the search system. The system searches over a plurality of data (informational) sources using intelligent query processing to retrieve information from the data sources and using intelligent result processing to determine relevant information from the retrieved information to be presented to a user or to be used for another search. The system can work with an explicitly spelled out strategy, such as a search program, as well as a strategy that alters only a subset of a resource's default behavior. Hence, the strategy need not specify the entire search behavior.

### BRIEF DESCRIPTION OF THE DRAWINGS

The objects, features and advantages of the present invention will become apparent to one skilled in the art, in view of the following detailed description taken in combination with the attached drawings, in which:

FIGS. 1A-1C show various search systems.

FIGS. 1D-1F show an exemplary strategy-based search system in accordance with the present invention;

FIG. 1F shows an exemplary illustration of a how a strategy could affect selection.

FIG. 1F illustrates another exemplary strategy-based search system for retrieving information from a plurality of data sources according another aspect of the present invention;

FIGS. 2A-2C are exemplary representations of the objects generated by the search system 100 for retrieving information from a plurality of data sources;

FIG. 3A is an exemplary representation of a query processor that processes a search query object depicted in FIG. 2A;

FIG. 3B is an exemplary representation of a data collector that processes a data request object depicted in FIG. 2B;

FIG. 3C is an exemplary representation of a result processor that processes a result object depicted in FIG. 2C;

FIG. 4 depicts an exemplary flowchart for a routing method to route the search query object in the query processor pool and for routing the result objects in the result processor pool;

FIG. 5A is an exemplary representation of the routing method described above with reference to FIG. 4;

FIG. 5B depicts an exemplary representation of local routing.

### DESCRIPTION

The present invention is directed towards improving search systems through the incorporation of search strategies.

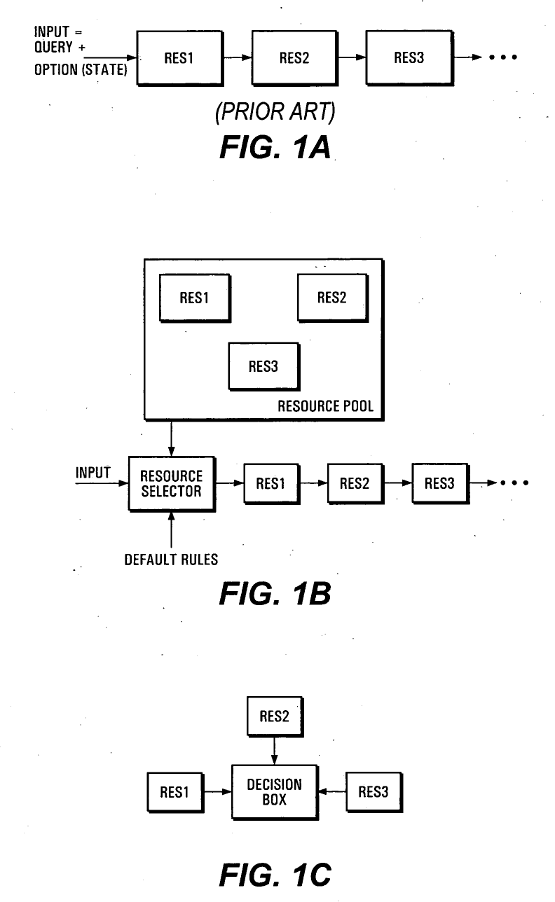

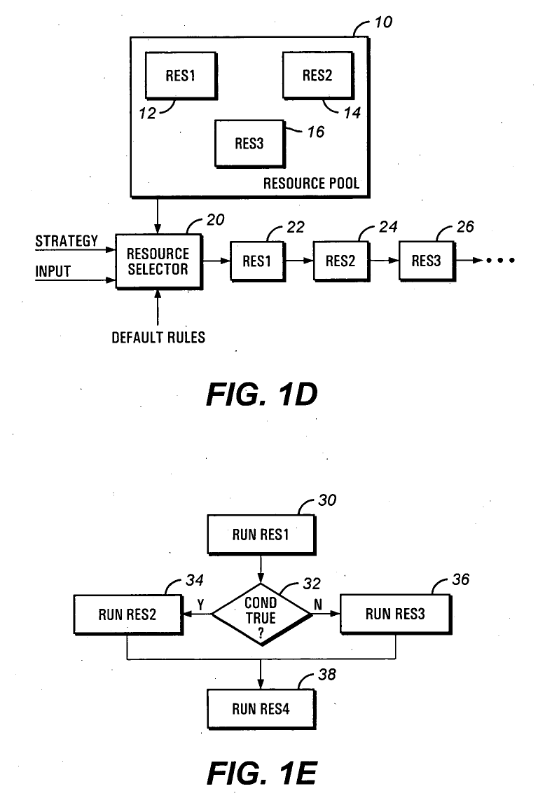

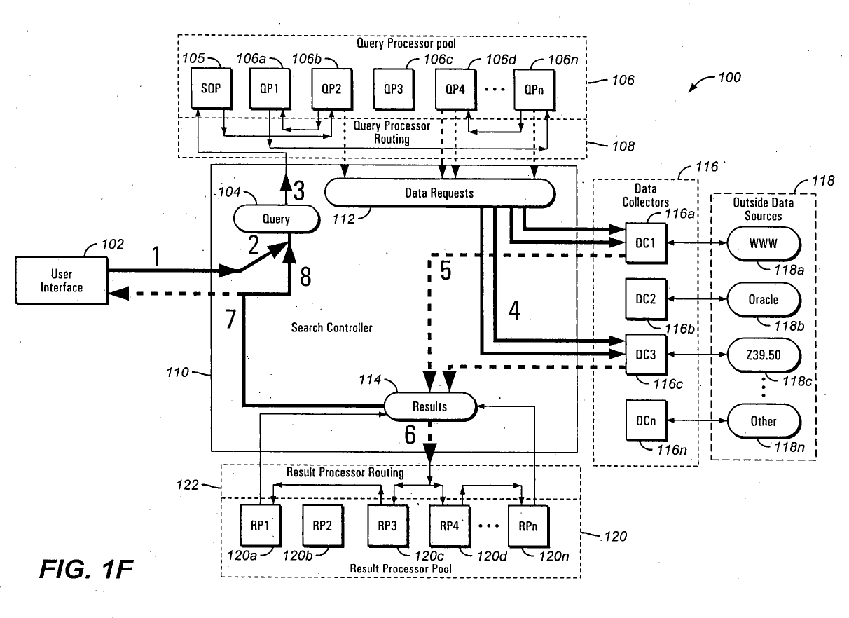

To illustrate the operation of strategy-based search system in accordance with the present invention, exemplary representations of conventional systems that do not incorporate search expertise are shown in FIGS. 1A-1C. In contrast, FIGS. 1D-1F show different implementations in accordance with the present invention where search expertise is incorporated into the search process (strategic searching).

FIG. 1A shows a conventional hard-coded search system with three search resources, search resource 1 (RES1), search resource 2 (RES2), and search resource 3 (RES3), among others. In this figure the user's input which can include a query and options (system state includes options) is processed by a plurality of resources in a pre-defined order. FIG. 1B is another conventional search system that has a similar behavior as FIG. 1A. In this case, the input is provided to a resource selector (“input” includes a query as well as options) with a default selection policy to select the resources RES1, RES2 and RES3. In this case the default selection policy results in the sequencing of same set of resources in the same order as FIG. 1A. Likewise adding RES 4 to the end of the list of FIG. 1A, and to the resource pool of FIG. 1B, and modifying the default selection policy could produce the exact same behavior. FIG. 1B is a different way of implementing the search system characterized by FIG. 1A. FIG. 1C shows another conventional system that uses resource selection. In this system RES1 decides whether to run RES2 or RES3 next. However the decision is hard-coded and although this system may appear to have a behavior similar to a strategy, it is not since the rules are defined in advance. Similarly, in another conventional hard-coded search system, an option decides if the second step is RES2 or RES3. Even though an option decides the selection of RES2 or RES3, this is not strategic searching since the behavior is defined in advance. Although the particular selection of resources might change based on if a condition is true or false, the rules are fixed in advance.

FIG. 1D illustrates an embodiment of a strategic search system in accordance with the present invention. The system of FIG. 1D is similar to that of FIG. 1B. The system includes a resource pool 10 with RES1 12, RES2 14, and RES3 16, among others. The resource pool 10 is provided to a resource selector 20 which receives a search input as well as a search strategy. Default search rules are also received by the selector 20. The resource selector 20 in turn selects and sequences resources at run-time as RES1′ 22, RES2′ 24 and RES3′ 26, among others.

The system of FIG. 1D changes the fixed behavior of the system of FIG. 1B into a strategic-based system by adding an extra input “search strategy,” which can modify the default selection policy during run-time. The strategy might modify a small part, such as switching RES2 14 and RES3 16 so that if a particular condition is false, the system dynamically makes the decision run RES2′ 24 ahead of RES3′ 26, for example. The unaltered parts remain the same—i.e. running RES1 first, choosing between RES2 and RES3, running the selected resource RES2 or RES3, then running RES4, for example. Although the sequence of executed resources shown in FIG. 1D happens to be identical to the default sequence, RES3 can be run ahead of RES2 based on the condition, for example. The search strategy, among other things might introduce new conditions not previously specified by the default rules.

In FIG. 1D, information is searched in accordance with a specified strategy for a search system having a plurality of resources and production rules for using, ordering and/or manipulating those resources. Based on the strategy provided to the search system, the search system augments its production rules and dynamically determines at run-time the selection or order of said resources according to said production rules along with the augmented production rules.

In one embodiment, the using includes providing a query to said one or more resources and receiving at least one result therefrom, the ordering includes determining a sequence in which the resources are queried, and the manipulating includes controlling the operation of said one more resources. To illustrate, computational resources are “used” when a function is called, and some operation occurs. Data resources are used when a query is provided and a set of results are returned. The system can order or place constraints on the sequence of execution of the resources. (i.e. first apply the thesaurus THEN apply the phrase-detector, or first call the page downloader THEN call the term extractor). The resources can be manipulated by affecting the operation of a computational or data resource, for example running a thesaurus with an option “query-language=Spanish.”

```
One exemplary pseudo-code for the operation of FIG. 1D is as follows:
  Initialize default rule and system state
  receive strategy & input, using default rule, strategy & input
  while search criteria is not met
      select next resource based on default rule, strategy &
    system state (includes input)
      run selected resource
      update system state as a function of resource output, current
    state and strategy
  end while
```

FIG. 1E shows an exemplary operation of the system of FIG. 1D for four resources RES1-RES4. First, the system runs RES1 (30). Next, based on the provided strategy, a condition is evaluated (32) and the system augments its rules and determines at run time the selection or order of RES2 and RES3. If the condition is true, the system runs RES2 (34). Alternatively, if the condition is false, the system runs RES3 (36). From either 34 or 36, the system then runs RES4 (38). The important difference between FIGS. 1E and 1B and 1C is that the condition in 1E was not part of the default rules, but rather transmitted as part of the strategy. Although the same flowchart could be accomplished from default rules, a strategy could be used to change those default rules to say switch RES2 34 and RES3 36, or to add RES5, or to change the condition.

In the system of FIGS. 1D-1E, search expertise is incorporated into the search process (strategic searching). One can view a typical search system as a flowchart, where inputs determine specific outputs in a predefined manner. Options may alter the flow through the flowchart, but they will not alter the fundamental interconnections of the resources. Strategic searching is the ability to alter some or all of the connections inside of this search flowchart. A simple example is the difference between always applying one search resource such as a thesaurus before applying another resource such as a query modifier. A search strategy could switch the order, and leave everything else alone. Likewise, a strategy could activate or deactivate resources, or add decision nodes into the flowchart, such as if today is Wednesday (day==Wed) then use the thesaurus (in the default manner), otherwise use the spell corrector. Again in this example, all the remaining defaults are left unaltered. Likewise, the default rules were never designed to consider the day of the week when making search decisions.

Another example where a strategy could improve searching includes a situation where a user may wish to include a thesaurus for a particular search and the high-level search strategy may accommodate this by incorporating a thesaurus such that the user's query is augmented with synonyms. In another example of strategy-based searching, the user can input a strategy where a heavily loaded system should skip the slow informational sources (e.g., databases), but only if there is sufficient coverage for the user's need. Thus, for example, it is desirable to enable the search system to produce a high-level search plan that searches all informational sources when the search system is not busy, but when the search system is handling many user search requests, the search plan accounts for this by excluding the slower information sources.

Search strategies might have no obvious effect for some combinations of searches. For example, a search strategy might say that RES2 must run before RES3 (even though the default is RES3 runs before RES2), however for one search, due to options or other conditions, maybe neither resource runs, or maybe only one resource runs, so the ordering constraint was not activated. In this case the strategy does not force RES2 to run immediately before RES3, it doesn't even mandate that either or both resources run at all, only that if both run, then RES2 should come first.

The search strategy can be specified by the user, or more commonly, specified by a system administrator at configuration time. Strategies could include querying different databases based on user location or profile information, using fallback sources or algorithms when the first attempt to find information fails, or altering the search methodology for particular search types based on past experience. However, unlike a hard-wired approach, where the rules are specified in advance, a strategy only modifies the routing algorithm selections at run-time, it does not explicitly specify a hard-wired course of action (although it could, in general it does not). The subtle difference between a hard-wired system that accepts options and a strategy-based system is important. In the hard-wired case, options could be used to select between a few specific choices—i.e. “use thesaurus if option#1=true”. In the strategy case, there is no code looking for specific options built-into the system, but rather the strategy alters the default behavior by modifying the parameters used by the routing algorithm. In some cases simple options might appear identical to a simple strategy, the difference is in how it is implemented and represented by the system.

In one embodiment, the search strategy is a partially specified set of rules or modifications to the routing defaults for controlling a set of search resources for a given search. Hence, the strategy could be loosely thought of as a language that has a construct called “use your own judgment.” For example: One possible search strategy would be “find documents about topic X, use a thesaurus if necessary and search the web sources and local databases”. Another strategy could be the same except adding: “don't search Google™”, or adding “use the generic relevance function or the web relevance function” and the system automatically determines which is best, such as sending web results to the web relevance function, and non-web results to the generic relevance function. The decision of which results to send to which function was not specified in the strategy (although a strategy could explicitly say that Google™ results go to the generic relevance function). In this context, the user specifies the strategy, and the system determines the tactics.

To use an analogy, a general (the user) makes a request to a soldier #1 (a resource) to “take ABC hill”, but the general does not need to explicitly request “soldier #1 move north 3 meters”. The system would determine that in order to take the hill, soldier #1 should move north. However, the general could say “Take the hill, don't move soldier #1” and the system would find a different solution. In this analogy, a search request with no strategy given is analogous to an order from the general to the soldier to “win the war” without more. This high level order can be improved through hints in the form of a strategy or suggestions—or in the extreme case an exact marching order for each resource.

A strategy is an optional specification that can alter or override a default system behavior or a default resource behavior. In one extreme, the strategy can override everything saying: First do X, then do Y, then do Z, except when Q, then do R. The strategy could simply request a slight change in the defaults—for example telling the system that a module that normally would run is not allowed to—or vice versa. The strategy might say “the thesaurus can run”, but it does not have to say when or how—the system defaults know how to do that for the typical case. The strategy could also be a modification of the conditions. For example, in order for a thesaurus to run it requires “user-authenticated” to be true and the strategy might simply override “user-authenticated” so now the thesaurus might run. The strategy can also override the default behavior for a particular resource, for example the strategy can instruct the thesaurus to run after the spell-checker and after the query modifier.

The strategy can alter which search resources are allowed to run (either adding new resources, or removing those allowed by default). The decision of which to add or remove could be conditional based on system state—such as “if day=Weds, then allow thesaurus to run, or if num_query_terms>10, do not allow thesaurus to run. The strategy can alter the system state, influencing how a module behaves. For example, if a result is a web result (type=web), but if the user does not want to run the web scoring, the setting can be changed to type=not-web. The strategy can alter the default ordering by providing explicit overrides in the form of local-routing. The routing process specifies given the current state which resource to be chosen next—As the state changes the next resource to run changes, as the allowed resources change, the next resource to run changes—however a strategy might impose a particular ordering at a specific point. So normally if the thesaurus and the query modifier are allowed to run (all else being equal) the query modifier runs after the thesaurus (maybe due to a difference in run-level, although the reason is irrelevant). However, a strategy can require for a particular search only, the query modifier runs, and then the thesaurus runs on its output. Normally this would be a bad idea, however if the searching expert wants this behavior, the strategy provides an easy mechanism for accomplishing a goal that is counter to the original defaults. Strategies do not require explicit knowledge of default rules. If a strategy specified that the thesaurus run after the query modifier, and the default rule said the same thing, there is no error or problem. The difference is that strategies take precedence over default rules.

FIG. 1F is an exemplary search system 100 for retrieving information from a plurality of data sources according to the present invention. The system of FIG. 1F has plurality of resources 106, 116, 118 and 120 and production rules for using, ordering and/or manipulating those resources. A strategy query processor (SQP) 105 augments the system's production rules based on a search strategy; and dynamically determines, at run-time, the selection or order of the resources according to the production rules along with the augmented production rules. In one embodiment, the SQP 105 gets control first, and can influence the order of resources selected following the SQP 105.

In FIG. 1F, a search strategy is communicated to the SQP 105, which accepts the strategy and uses the rules in the strategy to alter the default routing algorithm. In this implementation, a search strategy can be in the form of a list of requests to activate or deactivate resources, local routing directives (that are carried out by the SQP 105), modifications to the system state by setting or unsetting keys, or conditional operators over any of these. Although the actual strategies sent to the SQP 105 are not written as explicit production rules, the SQP 105 takes the provided strategy and uses it to augment the default production rules in the system, altering the selection and ordering of resources. The SQP 105 also is able to take conditional operators to activate or deactivate extra search passes.

In the system of FIG. 1F, the term “production rules” refers to the set of all existing instances of Production Rule in existence within the system. Production Rule is a construct consisting of one or more constraints on the system state. At each decision step, all of the matching production rules are considered. A matching production rule is one where all of the constraints (both positive and negative) are satisfied. The production rule to fire next (in this case which module is selected to run) is the one with the lowest priority. In the process of running the selected module, the system state is altered in such a way that the set of considered production rules might change. Some production rules that were previously considered might no longer be valid, or previous rules that were not valid become valid when a missing condition is satisfied. Each new epoch of system state should represent a query in a form closer to being completely executed. Each production rule when fired will advance system state in this way, either through the symbolic (key) space the production rules manipulate explicitly, or due to the side effects of an imperative code that is attached to production rules in the form of resources or modules. The rules and the resources/modules attached can alter the system state upon which production rules trigger.

In the context of FIG. 1F, augmenting refers to adding additional instances of production rules, adding additional constraints (conjunctive conditions) to a subset or all existing production rules, adding additional disjunctive conditions to a subset or all existing production rules or nullifying a subset or all existing Production Rules. All of the operations can affect any existing Production rules, including those that have been created during augmentation. Augmenting can bind new production rules to existing modules, but cannot result in the direct addition or alteration of the modules themselves.

The following illustrated flow in the search system 100 is exemplary in nature. The system 100 has a search controller 110, which interconnects a user interface 102, a set of query processors 106 (i.e., query processor pool), a set of data collectors 116 (i.e., data collectors), and a set of result processors 120 (i.e., result processor pool). Any of the user interface 102, the query processors 106, the data collectors 116 and the result processors 120 is also referred to hereinafter as a module. A user interacts with a user interface 102 to generate a query and a strategy input, which is transmitted to the search controller 110. The user interface 102 may be a conventional web browser, such as the Internet Explorer™ or the Netscape Communicator™, which generates a request for information and transmits the request to the search controller 110. The system 100 could be decentralized and system components communicate using messages. At the user interface 102, the user inputs a search via the user interface 102, which is preferably converted by the user interface 102 to a set of key-value pairs to be transmitted to the search controller 110. The search typically comprises a set of keywords and options, such as, search preferences. More specifically, the user interface 102 generates a set of key-value pairs that includes the user's request, plus other optional key-value pairs to guide the search. For example, if a user decides to search for “research papers” about “database algorithms”, the user may simply check a box “research papers” and type in keywords of “database algorithms” on the user interface 102. The user interface 102 accepts this information and generates a set of key-value pairs which includes the following keys and associated values:

SEARCH_TYPE=CATEGORY; CATEGORY_NAME=“RSRCH”;

INQ_ROUTE=Google™; Local_DB; Spell_checker; and Pref_scoring; and

KEYWORDS=“database algorithms.”

The search controller 110 determines whether the set of key-value pairs represents a valid query by verifying that it has a minimal set of requirements to perform the search. If the search controller determines that the set of key-value pairs does represent a valid query, the search controller generates a search query object 104. Alternatively, the user interface 102 generates the search query object 104 based on the set of key-value pairs and the user interface 102 transmits the search query object 104 to the search controller 110, which then determines whether the key-value pairs in the search query object represent a valid query. The search query object 104 represents a message.

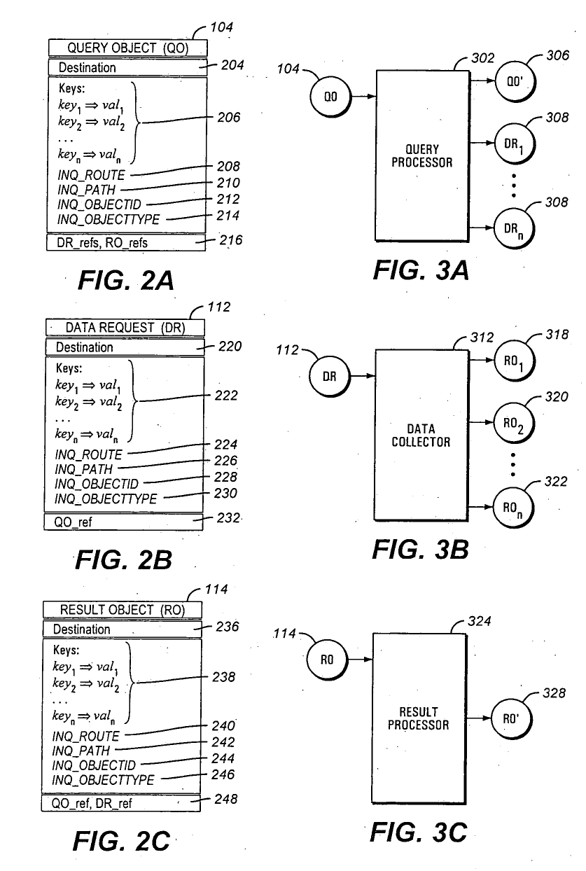

The search query object 104 is defined by and comprises the set of key-value pairs. In addition to the keys that describe the user's request, such as keywords and preferences described above, other keys may include routing information, intermediate variables, search context and pointers to other related objects, such as results that have been found. For example, a query object 104 may include the following key-value pair: THESAURUS_RUN=true. The key THESAURUS_RUN may be set by a query processor 106 described below (e.g., a thesaurus module) after it has operated on the query object 104. Additionally, the query object may include routing related keys such as INQ_ROUTE and INQ_PATH and associated values, which specify which query processors 106 are desired to run and which query processors 106 have already run, respectively. An exemplary representation of a search query object 104 is depicted in FIG. 2A below.

The search query object 104 is then processed by the SQP 105 (the default rules cause this to be the first module to run). In one implementation, the SQP 105 acts as an interface between the outside world and the internal routing algorithm. The SQP 105 is implemented as a module to comply with the application programming interface (API) of the search system and to perform evaluation of conditional operators in the strategies.

The SQP module 105 is run first by the default behavior, and once run, it has the ability to alter the routing of the remaining modules, as well as perform other strategic tasks such as requesting another pass (by setting or clearing an “extra-pass” key). In contrast to the system of FIG. 1D, the SQP does not specify an exact behavior, it modifies the parameters (production rules) that are used by the internal routing algorithm to determine which modules to choose and when. Although the SQP 105 could directly call another module based on a condition, in the preferred method, it does not do this—it relies on the internal selection algorithms, modifying the defaults as specified by the strategy.

In one implementation, the SQP also receives a strategy from the user's search query, or alternatively reads a configuration file, that allows certain types of operations. The strategy can be simple discrete operations that can be conditioned on the search state, user options (which are part of the search state), system parameters (such as system load and available resources, among others) or other factors (such as a timed event), among others.

The SQP 105 can augment the production rules through 1) the ability to send requests to different sources where each request was generated using different components; 2) extra control over multi-pass searching by allocating different resources (or resources with different options) on different passes; 3); Specifying which resources are activated or deactivated as a function of the system state and 4) search strategies can be specified without requiring a detailed understanding of resources and how they operate. It is even possible to define strategies over strategies—without explicit specification over resources at the higher levels. The augmenting of the system's production rules can nullify or can place additional constraints on the production rules at run-time. The search strategy can be specified at run-time. The search strategy can be specified by a user or can be hard-coded (programmed in advance). The search strategy can be implemented over a plurality of search passes. The system state can be communicated through a query. The system state can also be communicated in one or more messages passed among the resources. The search strategy includes conditional operators that are evaluated during the search. The resource includes one of query processing resource, result processing resource and data source. Each resource can be controlled in accordance with the search strategy and a system state. The production rules are not explicit in our exemplary system, but rather encoded in system-specific keys, such as INQ_ROUTE, and encoded in how other keys like “request_another_pass” are set. Modifying, deleting or adding new keys are how the implicit production rules are adjusted. These keys also encode the default system behavior that is being modified by a search strategy.

The SQP 105 has the ability to capture and utilize human expertise, and to combine multiple strategies together as needed. For example, if the user asks a human librarian how he or she would locate a specific piece of information, the librarian could tell the user the actual strategy used—this strategy could be “captured.” The SQP makes it easy to specify and enter this strategy so future searchers can reuse the strategy as appropriate.

The SQP 105 allows a simple specification of high-level search strategies over a set of modules. Each strategy can be conditional on the state of the search, or user parameters and these strategies can be entered without requiring recompiling of the system or knowing low-level details of how individual modules operate. The SQP 105 utilizes a strategy, which in turn, based on conditions, enables or disables other strategies and modules at each pass or intra-pass “fork” in the search. The SQP can also influence how system components operate, by setting “keys” that are used by specific components. In FIG. 1F, the SQP 105 works by loading a (text-based) configuration file that specifies a simple set of high-level search strategies. Alternatively, the strategy specification can be embedded inside a particular search. Changing of the strategy would not require recompiling any modules. In addition, strategies can be specified explicitly by a user, and transmitted along with the query.

The search strategy can include a simple operation such as: specifying the complete ROUTE, or specifying specific modifications to the ROUTE. i.e. add Thesaurus. Alternatively, the search strategy can be a variable operation that sets a variable (key) to a value, or unsets a key. Other functionalities include conditional operations, such as: If (UI-DoThesaurus=true), then activate strategy “Include-Thesaurus”. Also, advanced functionality includes utilizing local routing and operations on specific data requests. For example, the user could specify a strategy Query-Google™ that might include generating data requests, applying the Thesaurus (only to those data requests) and then adding Google™ to the ROUTE of only those data requests. This strategy can be specified and run independently from a strategy to query Medline operating only on specific subsets of data requests. Strategies can also be conditioned on passes as well as specify the conditions when another pass should be run. For example, a strategy could be: if (pass==2) then activate a Google™-Search strategy. Likewise, the strategy could say: RequestExtraPass if (num-good-result<12).

The output of the SQP 105 causes the system state to update. The change in system state (modification of keys) can be read by and of the query processors 106 (i.e., the query processor pool) which comprises a plurality of query processors QP1-QPn (106a-106n). The SQP 105's modification to the query object 104 effectively determines (by modification of the default rules) which query processors QP1-QPn (106a-106n) to run and a routing sequence for the query processors 106. It does not explicitly specify the sequence.

The SQP 105 can modify the query message or object 104 by adding, deleting, or changing of keys. Alternatively, the SQP 105 can modify any Data Request (DR) objects by adding, deleting or changing of keys. The SQP 105 can also create new Data Requests (DRs) or delete an existing DR. The SQP 105 can also alter the ROUTE (either the main INQ_ROUTE, or that of a DR. Moreover, the SQP 105 can manually route the objects to other modules, either individually or collectively (local routing). It can also answer or generate Control Messages. Additionally, the SQP 105 can set or modify the NEXT_PASS condition, thus affecting subsequent searches.

The strategic search system abstracts the strategy out of a hard-coded program so the strategy can be specified separately from the program. The system allows the user to submit a query with no program and the system would automatically determine its course of action. A user could also send a fully-specified search program. The user could send a strategy in the form of hints, suggestions or constraints on the default behavior.

In another implementation, the system can define Search Categories and then perform searches within these categories. When a search is performed, the system will modify the queries sent to the back end search-engines (or data sources) and process the results sent back by those data sources to ensure the results are within the category. The system can utilize any structure or data that a source provides. When a source does not provide relevant data, the system can compensate for this with categorization, among others. For example, once a category has been defined, it can be selected in the search interface and submitted, along with keywords, as part of a query. The system will then use this category when performing the search. The system allows categories to be defined irrespective of the structural information in the database. For example, a user can search for information in the category of “Press Releases” even if the documents in the database are not labeled with respect to whether or not they are press releases. Existing metadata can be used to aid in classification judgements, but the existence of relevant metadata is not required. The system helps to unlock the ‘hidden riches’ of the underlying data sources, allowing that data to be accessed in ways that were not imagined or accounted for when the data source was created. It is possible, for example, to do a search for documents in a question-and-answer format (Frequently Asked Questions or FAQs). Even though a particular FAQ may not contain the word FAQ or the phrase question-and-answer, or the phrase “Frequently Asked Questions”, the system can still find such documents based on their structural features.

The set of query processors 106 (i.e., the query processor pool) comprises a plurality of query processors QP1-QPn (106a-106n). The search controller 110 determines which query processors QP1-QPn (106a-106n) to run and a routing sequence for the query processors 106. The routing for the set of query processors 106 is determined one query processor at a time based on a current state, i.e., key-value pairs in the query object 104, and specific properties of each query processor. The search controller 110 updates the value of the aforementioned key INQ_PATH to record the actual execution sequence of the query processors specified in the INQ_ROUTE, by updating the INQ_PATH after a particular query processor has been executed. More specifically, the INQ_PATH is an encoded list of query processors 106 (i.e., module names) and associated capabilities. A capability represents a possible action and an associated condition a module can take. For example, a “spell-corrector” query processor may have two capabilities, one for English queries and one for Spanish queries. English queries may require that a key QUERY_IS_IN_ENGLISH to be set (i.e., have a value), and Spanish queries may require a key QUERY_IS_IN_SPANISH to be set. Every time a query processor 106 (i.e., module) is executed for a specific matching capability, the query processor (module name) and the associated capability are appended to INQ_PATH, so that the search controller 110 does not send the same search query object 104 to a query processor for the same reason more than once during normal query processor pool routing 108.

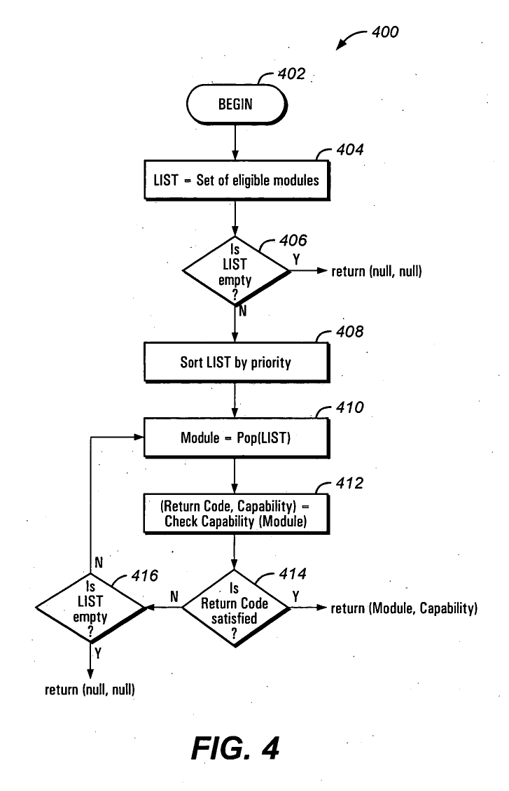

For example, the search controller 110 determines that the query object 104 is first routed to QP2 106b (after the SQP 105 has run), then routed to QP1 106a, and further routed by QPn 106n. Thus, the search controller 110 provides the search query object 104 to the first query processor QP2 106b for processing in accordance with the routing method described below in FIG. 4. The search controller 104 receives the query object 104 after processing performed by the first query processor QP2 106b. Then, the search controller 110 determines the next query processor that is to process the search query object 104, i.e., QP1 106a, in accordance with the method described below in FIG. 4. As illustrated in the exemplary query processor routing 108, the search query object 104 initially begins to traverse the query processors according to the initial route determined by the search controller 110 (i.e., INQ_ROUTE). Along this route, each of the query processors QP1-QPn (106a-106n), when executed, is enabled to add, modify and delete one or more key-value pairs from the search query object 104. For example, a spell correcting query processor may delete a key-value pair represented by the key THESAURUS REQUESTED if it detects a spelling error in a particular key-value pair in the query object 104, likewise a query analyzer module may set a key QUERY_IS_IN_SPANISH by analyzing the value for the key KEYWORDS. Furthermore, each of the query processors QP1-QPn (106a-106n) and the SQP (105) is enabled to modify an initially specified INQ_ROUTE key that influences which query processors are desired to be executed. Thus, a query processor may change the initial route specified in the key INQ_ROUTE defined by the search controller 110. For example, the initial route may not include QP2 106b, but QP1 106a or the SQP (105) may modify the initial route by specifying that QP2 is to be executed. FIG. 1F is exemplary in that it depicts one possible path that may be taken for a query object 104 through the query processor pool 106. FIG. 1F depicts a particular example of actual decisions of which query processors are run and in what sequence as the query object 104 traverses through the query processor pool 106. It is noted that not all of the query processors QP1-QPn (106a-106n) are executed for every search. As such, in FIG. 1, query processor QP3 106c is not executed for the query 104.

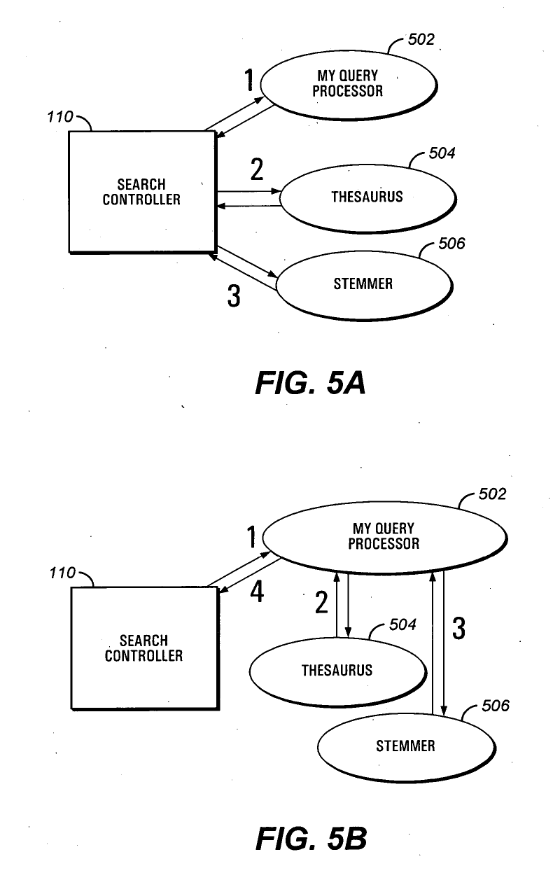

The foregoing modification of the INQ_ROUTE does not specify the sequence of execution for the query processor 106, but rather instructs the search controller 110 that other query processors previously not specified are allowed to be executed, or query processors previously specified are no longer allowed to be executed. In addition to altering the key INQ_ROUTE which controls the query processors that are allowed to be executed, any query processor can operate using “local routing” where a local INQ_ROUTE, and a local INQ_PATH can be established, which in effect forces a specific query processor to be executed next, notwithstanding the fact that the search controller 110 may normally specify a different query processor to be executed next, as described with reference to FIG. 5B below. For example, a thesaurus query processor may require a spell-check to be performed, as a result the thesaurus query processor may set a local INQ_ROUTE that includes the spell-check query processor, even though the spell-check query processor has already been executed, or may not normally be executed next. Since the INQ_PATH is also local, the spell-check query processor might be run a second time due to the non-local routing.

A query processor 106 that is specified to run next by the search controller 110 is a query processor on the route that has a lowest priority and that has a matching capability that has not already been used. More specifically, the value of key INQ_ROUTE lists the modules that are allowed to execute. Even though the result processors or data collectors are not allowed to run during query processor routing, the INQ_ROUTE includes in addition to query processors, result processors as well as data collectors. This is because the INQ_ROUTE gets copied to the data requests, and later to result objects. The value (key-value pair) for the key INQ_ROUTE is initially specified by a search administrator and may be modified by a query processor QP1-QPn (106a-106n) or by the SQP (105), when the query processor is executed. It is noted, that the user interface 102 may alternatively specify an initial route via the key INQ_ROUTE. The priority level of each query processor can be specified in one or more configuration files, or as part of the query processor source code. A capability is simply a list of keys that must be present or absent for a query processor to be enabled. For example, a Thesaurus query processor may have a default capability that requires a key “KEYWORDS” to be set and a key THESAURUS_RUN not to be set. Additionally, a particular query processor can have a plurality of capabilities. A query processor can also be executed more than once on a single pass through the search system 100 if it has more than one matching capability, or is called as part of a local routing by another query processor, as described below with reference to FIG. 5B.

Each of query processors QP1-QPn (106a-106n) is enabled to generate zero or more data request objects based on the search query object 104 to be transmitted to the search controller 110. Each data request object is a message. Each generated data request object is logically attached to the search query object 104 and can be accessed by the query processors QP1-QPn (106a-106n). For example, QP2 106b may generate a data request, which specifies that a Google™ search appliance should be searched with a synonym of a particular user search term in the key KEYWORDS. That is, although not depicted in FIG. 1, QP3 106c may be executed after QP2 106b and take action based on the fact that there is already a data request generated by QP2. Similar to the search query object 104, the data request object likewise comprises a set of one or more key-value pairs as shown in and described with reference to FIG. 2B. Furthermore, the data request object represents a request for data from a particular data collector or a set of data collectors DC1-DCn 116. As such, the data request object includes its own INQ_ROUTE, which specifies a data collector DC (116a-116n) to which the data request is to be transmitted. The search controller 110 receives the data request objects generated by the query processors QP1-QPn (116a-116n) at data requests 112. When the search controller 110 has completed query processing, the search controller 110 transmits the received data requests 112 in parallel to the respective data collectors 116.

Each data collector DC1-DCn (116a-116n) of the data collectors 116 is enabled to communicate with a corresponding outside data source 118a-118n of the outside data sources 118. A respective data collector DC1-DCn (116a-116n) receives a data request transmitted from the search controller 110 and communicates to an associated outside data source 118a-118n. It is noted that the data requests include references back to the search query object 104, so if necessary, a data collector 116 can access the key-value pairs in the search query object 104, as well as the key-value pairs in the associated data request object. For example, in FIG. 1, the data collector DC1 116a receives two data requests from the search controller 110 and based on the received data requests, generates and transmits appropriate requests to the associated outside data source 118a, i.e., a World Wide Web (WWW) search engine. Each of the data collectors 116 is responsible for interpreting the key-value pairs in the data requests that it receives from the search controller 110. As another example, the data collector DC3 116c also receives two data requests from the search controller 110, and based on the data requests generates and transmits appropriate requests to the associated outside data source 118c, i.e., Z39.50 is a well known library protocol. It is noted that the requests generated by the respective data collectors DC1 116a and DC3 116c for in the foregoing two examples are different. Specifically, a Z39.50 request for the associated outside data source 118c is different from a request to a WWW search engine 118a, even though the requests may include virtually identical key-value pairs. On the basis of the key-value pairs in the data requests object that is received from the search controller 110, each data collector is enabled to generate an appropriate search request to the associated outside data source. For example, as depicted in FIG. 1, the data collector DC1 116a is enabled to generate an HTTP request to a WWW search engine, and the data collector DC3 116c is enabled to generate a low-level network connection using the Z39.50 protocol. The list of outside data sources 118 is non-exhaustive and the modular design of the search system 100 facilitates the provision of a variety of other outside data sources without departing from the present invention. A data source may be a search engine or a protocol used to search for relevant data or information and search over the plurality of data sources represents a search. It is noted that additional data collectors may easily be provided and incorporated into the search system 100.

Additionally, each data collector DC1-DCn (116a-116n) interprets the results returned from the requests to the each associated outside data source 118. From each result, a result object is created by the respective DC1-DCn (116a-116n). Each result object is a message. Like the search query object 104 and the data request object, the result object comprises a set of key-value pairs. The data collectors 116 asynchronously transmit the result objects to the search controller 110 results 114 for subsequent processing. As each result object is asynchronously received, the search controller 110 routes the result object to the appropriate result processors RP1-RPn (120a-120n), in identical fashion to how the search query object 104 is routed between query processors 106. The primary difference between the routing of result objects and query object is that for a single search there is exactly one search query object 104, which is routed serially through query processors. However, for a single search there may be a plurality of result objects, and the plurality of result objects are individually run serially through the result processor pool 120 in parallel with one another. Additionally, at any given time, there may be many result objects being simultaneously processed by result processors RP1-RPn (120a-120n) in the result processor pool 120. The processing performed by the result processors 120a-120n may include, but is not limited to, relevance scoring, logging and other analysis. Generally, the result processors 120 will modify a given result object by adding, deleting or modifying the key-value pairs. Although not shown in FIG. 1F, a result processor 120 may generate a new result object, or modify the key-value pairs in the search query object 104. An example may include a result processor that counts the number of results, the score of which is greater than some value; this count could be stored in the search query object 104, or in a local memory of the result processor 120. The search controller 110 determines which result objects are to be transmitted to the user interface 102 for display. The search controller 110 waits until all pending data requests have completed and all result objects have been routed, and then determines if the search should end or if the search query object 104 is to be sent into the query processor pool 106 for another searching pass. As described above, the search controller 110 interconnects the query processor pool 106, the data collectors 116 (and the outside data sources), as well as the result processor pool 120, to produce result objects that are transmitted to and displayed at the user interface 102.

Further with reference to FIG. 1F, search system 100 is enabled to perform multi-pass searching as depicted in FIG. 1F. Unlike traditional federated searching where a single request (or set of requests) is made and results of the searching are processed and scored, the search system 100 can perform multiple search passes before completing the search. Multi-pass searching can be useful for searching that may comprise several possibilities where there is a chance of failure for any subset of them, i.e., such as searching a specific database that is then followed by searching a broader slower database. For example, if there are relevant results in the specific database, then there is no need to search the more general slower database—this desired behavior might be specified through a strategy sent to the SQP 105. Likewise, multi-pass searching can be used to create a new query based the result objects generated on a first search pass through the search system 100, such as by using query expansion and relevance feedback. A multi-pass search through the search system 100 occurs when there is at least one module (i.e., a query processor, a result processor or a data collector) that requests another pass, and there is no module vetoing another pass. Typically, the SQP 105 will vote based on the provided strategy. Additionally, any module can abstain from voting (the default) for whether there is to be another pass through the search system 100. That is, a default of the search system 100 is not to run any additional passes with every module abstaining from anotherpass, in which case the single vote by the SQP will determine if there is to be another pass. At the end of a search pass through the search system 100, any module (i.e., a query processor, a result processor or a data collector) that was executed during the search pass is run again to vote for another pass. For example, a first query processor may decide on the first search pass to make a data request to search a specific data collector. At the end of the first search pass, the search controller 110 executes the first query processor again, this time to vote for whether to perform another search pass through the search system 100. The first query processor may count the number of result objects generated during the first search pass, (for example, 10 result objects), and may decide that this number is not enough and vote for another pass. As another example, a second query processor may vote to veto another search pass because the search system 100 is too busy and another search pass may cause the system to get even slower. One veto from a module (i.e., second query processor) is sufficient to kill another search pass. If the second query processor abstained from voting (default), then the vote by the first query processor for a second pass would stand and an additional search pass would be executed by the search system 100.

On the second search pass the search query object 104 is routed again, just as described above in FIGS. 1, 4 and 5A-5B. It is preferable that the keys of the search query object 104 are not altered between passes. For example, if a thesaurus key THESAURUS_RUN were set in the search query object 104 on the first search pass, that key would still be set for the second search pass. It is preferable that the key INQ_ROUTE is set to the same value it was at the end of the previous search pass. Alternatively, the INQ_ROUTE may be set to a default value for each additional search pass. Thus, if a particular module added a module to be executed to the INQ_ROUTE in a first search pass, then that module would be listed in the INQ_ROUTE for the next search pass. Since the search query object 104 is the same from one search pass to the next search pass, the data requests and result objects associated with the search query object that were previously generated on an earlier search pass are still available for use by the search system 100 on the next pass. The search system 100 on a subsequent search pass operates identically to that of other passes, i.e., routing operates the same way as described herein—performing query processor routing, then sending data requests to the appropriate data collectors, and then performing result processor routing for each result object.

FIG. 1F shows one possible implementation of a search system that has been augmented to utilize strategies. Although the example in FIG. 1F is a meta-search system, strategies can be added to any information processing system, even one that does not do meta-search.

FIGS. 2A-2C are exemplary representations of the objects generated by the search system 100 for retrieving information from a plurality of data sources according to the present invention. The FIGS. 2A-2C depict three specific system objects, which permit communication between modules (i.e., user interface 102, query processors 106, data collectors 116 and result processors 122) and the search controller 110. The three system objects depicted in FIGS. 2A-2C are as follows: search query object (i.e., “QO”) 104; data request object (i.e., “DR”) 112; and search result object (i.e., “RO”) 114.

As depicted in FIG. 2A, the search query object 104 comprises a destination 204 that specifies a stage in which the query object is, i.e., query processing stage, data collecting stage or result processing stage. As described above with reference to FIG. 1, the key-value pairs 206 specify the user's search request and any other optional information to guide the search. The search query object 104 further comprises an INQ_ROUTE 208 that is a reserved key-value pair in which the value part of the pair lists modules, including query processors 106, data collectors 116 and result processors 120, which are requested to be activated or run for a particular search. The search query object 104 is routed through the query processors 106 in accordance with the INQ_ROUTE key-value pair. Any query processor 106 can modify the INQ_ROUTE key-value in the search query object 104. The search query object still further comprises an INQ_PATH 210 that is a reserved key-value pair in which the value part represents a path taken by the search query object through the query processors 106. The INQ_OBJECTID 212 is a unique identifier assigned to the search query object by the search controller 110. The INQ_OBJECTTYPE 214 represents the type of an object, i.e., a search query object 104, a data request object 112 (described in FIG. 2B) and a result object 114 (described in FIG. 2C). Lastly, the search query object comprises references 216 to the data request objects 112 and to the result objects 114, which are associated with the search query object 104.

As particularly depicted in FIG. 2B, the data request object 112 comprises a destination 220 that specifies a stage in which the data request object is, i.e., query processing stage, data collecting stage or result processing stage. In general, the key-value pairs 222 specify information that is particularly specific and useful by the target data collector(s) 116 to access the associated outside data source 118, e.g., login username and password, specific database information and the like. In addition, the key-value pairs 222 may also specify optional information that is relevant to the search keywords (e.g., synonyms for search terms), as well as information that is relevant to result processing via result processors 120 (i.e., scoring of results from a particular data source 118). The data request object 112 further comprises an INQ_ROUTE 224 that is a reserved key-value pair that determines which modules are allowed to run. The INQ_ROUTE 224 is initially copied from the INQ_ROUTE 208 of query object 104. When a data collector 116 generates a new result object 114, the data collector by default copies the value of INQ_ROUTE from the data request object 112 to the INQ_ROUTE in the new result object 114. Any query processor 106 can modify the INQ_ROUTE key-value pair in the data request object 112. Thus, the INQ_ROUTE 222 may be different from INQ_ROUTE 208 based on the modifications by the query processors 106. The data request object 112 still further comprises an INQ_PATH 226 that is a reserved key-value pair in which the value part represents the path taken by the data request object 112. The INQ_OBJECTID 228 is a unique identifier assigned to the data request object 112 by the search controller 110. The INQ_OBJECTTYPE 230 represents the type of an object, i.e., a search query object 104 (described in FIG. 2A), a data request object 112 and a result object 114 (described in FIG. 2C). Lastly, the search query object comprises a reference 232 to the search query object 104, which is associated with the data request object 112.

As further particularly depicted in FIG. 2C, the result object 114 comprises at destination 236 that specifies a stage in which the query object is, i.e., query processing stage, data collecting stage or result processing stage. In general, the key-value pairs 238 specify information that is particularly specific and useful by the result processors 120 for routing the result object 114. In addition, the key-value pairs 238 may also specify optional information, such as, scoring information or data to be displayed on the user interface 102, such as relevance score or extracted summary. The result object 114 further comprises an INQ_ROUTE 240 that is a reserved key-value pair in which the value part of the pair lists modules, including query processors 106, data collectors 116, and result processors 120 requested to be activated or run. Although, the query processors 106 listed in the INQ_ROUTE 240 are not relevant to result routing 122, they may be there because the INQ-ROUTE 208 is copied from the search query object 104. The result object 114 is routed through the result processors 122 in accordance with the INQ_ROUTE 240 key-value pair. When a data collector 116 creates a new result object 114, by default the INQ_ROUTE 240 of the new result object 114 is copied from the INQ_ROUTE 224 of the data request 112 that was used by the data collector 116. Any result processor 122 can modify the INQ_ROUTE 240 key-value in the result object 114. The result object 114 still further comprises an INQ_PATH 242 that is a reserved key-value pair in which the value part represents a path taken by the result object through the result processors 120. More specifically, the INQ_PATH is an encoded list of result processors 120 and associated capabilities. The result processor routing 122 functions the same way as query processor routing 108, where the INQ_PATH is used to prevent a result processor from being called more than once for the same capability. The INQ_OBJECTID 244 is a unique identifier assigned to the result object 114 by the search controller 110. The INQ_OBJECTTYPE 246 represents the type of an object, i.e., a search query object 104 (described in FIG. 2A), a data request object 112 (described in FIG. 2A) and a result object 114. Lastly, the search query object comprises references 248 to the search query object 104 and data request objects 112, which are associated with the result object 114.

FIG. 3A is an exemplary representation of a query processor 302 that processes a search query object 104 depicted in FIG. 2A according to the present invention. As described above with reference to FIG. 1F, the query processor 302 is a module that operates on a search query object 104 and is enabled to add, modify or delete key-value pairs in the search query object 104. FIG. 3A illustrates this by the input of the search object QO 104 to the query processor 302 and its modification to a search object QO′ 306. For example, a simple type of query processor 302, e.g., a thesaurus query processor, may take an input query object 104 and add a new key called SYNONYMS whose value represents synonyms of the original query terms in the search query object 104. Furthermore, another type of a query processor may modify user's key KEYWORDS and add one or more specific search terms to the value of the key KEYWORDS. For example, a user searching for product reviews about a Palm Pilot may specify a key CATEGORY whose value is prod_reviews on the user interface 102. In this case, a special query modification query processor may detect that key and add reviews to the value of the key KEYWORDS. The query processor 302 is further enabled to generate one or more data requests DR1-DRn 308-310 for each search query object 104. A more sophisticated approach to the previous example is a query processor 302 that looks at the specific key CATEGORY and then generates one or more data requests DR1-DRn 308-310 for each particular data collector 116 associated with an outside data source. In the case where the key CATEGORY includes the value product_reviews, the query processor 302 may, for example, generate three data requests. The first generated data request is for CNET™ (a web search engine specializing in technology products), in which a key-value pair “KEYWORDS=palm pilot” is added and the value of the key INQ_ROUTE is appended with “CNET™.” The second generated data request is for a local database that adds a key-value pair “NUM_REUSLTS=5”, a key-value pair “QUERY_TYPE=AND”, a key-value pair “SEARCH_CATEGORY=prod_rvw”, a key-value pair “KEYWORDS=palm pilot”, and lastly a value “LOCAL_DB” is appended to the value of the key INQ_ROUTE 224. Lastly, the third generated data request is for Google™ (a web search engine), which in addition to setting the route INQ_ROUTE 224 for the data request 112 to include “Google™”, uses a value of “palm pilot reviews” for the key KEYWORDS. Also, a different value for the key CATEGORY would result in a different number or different set of data requests. More specifically, if “CATEGORY=medical” then the query modification query processor described above may have decide to search using a “Medline” data collector 116 instead of CNET™, and would not have added “reviews” to the key KEYWORDS for the data request 112 to Google™. In addition, the query processor 302 may modify the INQ_ROUTE to influence to which query processor the query object 104 is routed to next. More specifically, the query processor 302 may add other query processors to the current key INQ_ROUTE. The query processor 302 may also add data collectors 116 or result processors 120 to the INQ_ROUTE 224 of a data request DR1-DRn 308-310, or to the INQ_ROUTE 208 of the associated search query object 104. The INQ_ROUTE of a data request determines which data collectors 116 the data request is sent to. The data requests DR1-DRn 308-310 inherit the INQ_ROUTE of their parent query object 104.

FIG. 3B is an exemplary representation of a data collector 312 that processes a data request object DR 112 depicted in FIG. 2B according to the present invention. As described above with reference to FIG. 1F, the data collector 312 is an interface between the search system 100 and an outside data source 118. The input to the data collector 312 is a data request 112. As described in FIG. 2B, the data request 112 includes a key INQ_ROUTE that is used to specify a default value for one or more result objects RO1-ROn 318-322 that the data collector 312 generates based on the data request object 112. The data collector 312 performs several actions as follows. The data collector 312 is enabled to create, modify or delete any keys of either the data request 112 that it processes or of the original search query object 104 to which it has a reference 232, as depicted in FIG. 2B. More specifically, the data collector 312 may wish to use the original search query object 104 as a blackboard to store information, such as the time a search took, how many results were found, any response codes, and the like. The data collector 312 utilizes the data request 112 to generate an appropriate search request to an associated outside data source 118, as depicted in and described with reference to FIG. 1F. Upon receiving a response from the associated outside data source 118, the data collector parses the response, generates a corresponding result object RO1-ROn 318-322 and sends the result object to search controller 110. The value for the key INQ_ROUTE 240 of the result object RO1-ROn 318-322 is by default copied from its parent data request object 112. For example, a query processor 302 may generate a data request object DR1 to search Google™, a general-purpose search engine. Thus, the query processor 302 sets the value of the key KEYWORDS to “palm pilot review” and adds “Google™” to the INQ_ROUTE for that data request object DR1 308. Since Google™ is on the INQ_ROUTE 224 of the data request object 308, the data collector 312 associated with searching Google™ will receive the data request object DR1 308, assuming that all requirements are satisfied as will be described with reference to FIG. 4 below. The data collector 312 extracts the value of the key-value pair represented by the key KEYWORDS from the data request object DR1 112 and sends the value as a web query to the Google™ website, i.e., an outside data source 118 associated with the data collector 312. A response web page from the outside data source, Google™ is then parsed (data collector 312 associated with Google™) and several result objects RO1-RO1 n 318-322 are created. The first result object RO1 318 is titled “Palm Vx,” the second result object RO2 320 is titled “Sony CLIE,” and the third result object ROn is titled “Samsung I300.” Each of the result objects RO1-RO1 n 318-322 will have its own INQ_ROUTE specifying which result processor(s) 120 are to be used to process the result object. The data collector 312 associated with Google™ may also set a new key INQ_RESULTTYPE=web or INQ_WEBRESULT=true to specify that these results objects represent web pages. In addition, the data collector 312 may set a key INQ_TITLE that represents the title for each result object RO1-RO1n 318-322 (i.e., web page), and INQ_URL that represents the universal resource locator (i.e., “URL”) of each result object (web page).

FIG. 3C is an exemplary representation of a result processor 324 that processes a result object RO 114 depicted in FIG. 2C according to the present invention. The result processor 324 processes a result object RO 114 to generate a a result object RO′ 328. There are several kinds of result processors, including those that perform relevance scoring, keyword highlight, feature extraction and logging. It is noted that the list of result processors is non-exhaustive. The result processor 324 is enabled to create, modify and delete keys, both in the result object 324 and those of the parent data request object 112 and the parent search query object 104. The result processor is also enabled to modify the INQ_ROUTE 240 depicted in FIG. 2C, to specify to which result processor the result object 324 is to be sent next. For example, a web scoring result object 324 may add a value of Web Page Downloader to the key INQ_ROUTE 240 if a web page represented by the result object 324 should be downloaded. Likewise, the result processor 324 may remove a result processor from INQ_ROUTE 240 to prevent unnecessary execution of a result processor, such that the result processor 324 may remove Extract Date result processor from the INQ_ROUTE 240 of the result object 114, which already has a date field specified, thereby mitigating the execution time of running the Extract Date result processor.

FIG. 4 depicts an exemplary flowchart for a routing method 400 that exemplifies routing decisions 108 for routing the search query object 104 in the query processor pool 106 and routing decisions 122 for routing the result objects 120 in the result processor pool 120, in accordance with the present invention. For clarity and brevity, a query processor or a result processor is referred to as a module in the flowchart 400. The routing method 400 starts at step 402 where the search controller 110 executes the routing method 400 to determine which module (i.e., query processor or result processor) should be run next. At step 404, a list of modules that are eligible to be executed is generated. The list of eligible modules represents modules of a correct type that are listed in the value of the key INQ_ROUTE and have at least one capability that has not yet been used. The modules of correct type are determined based on a current stage, i.e., query processors 106 for query processor routing 108 and result processors 120 for result processor routing 122. The key INQ_PATH 210, 242 for the search query object 104 and the result object 114, respectively, records which modules (search query processors or result processors) have been run and for which capability. If capability is unused, the corresponding module and the capability are not listed on the key INQ_PATH 210, 242. This prevents a module from running more than once for the same capability, but allows a module to run more than once for a different capability as may be appropriate. As described herein, the INQ_ROUTE is a list of modules (i.e., query processors, data collectors, and result processors) that are desired to be run or executed. At step 406, it is determined whether the list generated at step 404 is empty. If the list is empty, the routing method returns a NULL result to the search controller 110, specifying that there are no muddles left for the current search stage. Alternatively, if the list is not empty as determined at step 406, the list of muddles is sorted by their priority at step 408.

Further with reference to FIG. 4, at step 410, the first module in the list is removed from the list (i.e., popped from the list). At step 412, a CheckCapability( ) function is executed to determine a capability and a return code for the first popped module. More specifically, the CheckCapability( ) function determines if the popped module has any unused capabilities that are satisfied. A capability is a list of keys that are required to be present or required to be absent, and a capability is satisfied if all the keys that are required to be present are defined in either the current object (described below) or its parent data request or grandparent search query object, and all of the keys that are required to be absent are absent in the current object and its parent data request and its parent search query object. If the current object is a search query object 104, such as during query processor routing 118, then there is no parent data request object or search query object. The function CheckCapability( ) returns either a (NULL, NULL), which indicates that the popped module does not contain an unused capability, or returns (“satisfied”, capability), which indicates that the capability is unused. At step 414 it is determined whether the return code is “satisfied” or NULL. If the return code is “satisfied”, then the first popped module and its capability are returned as a module to which the current object is to be routed. Alternatively, if the return code is not “satisfied” (i.e., NULL) at step 414, at step 416 it is determined whether the list is empty. If the list is empty, the routing method returns a NULL result. Alternatively, if the list is not empty at step 416, then the method continues at step 410 where the next module is popped from the list of modules and the steps 412-416 are repeated. The routing method 400 returns a module from the list of modules with a lowest priority level that has a matched but not used capability. When the module is run for the associated capability, the matched module and capability are added to the INQ_PATH of the current object so that they are not executed again.

FIG. 5A is an exemplary representation of the routing method described above with reference to FIG. 4, which satisfies a general case where certain desired modules are specified in the key INQ_ROUTE. The search system 100 attempts to execute each module specified in the INQ_ROUTE, based upon that module's priority and capabilities as described above. In accordance with the routing method 400 of FIG. 4, in FIG. 5A, the search controller 110 first executes a query processor “My Query Processor” 502. When the query processor 502 has finished its execution, control returns to the search controller 110 and the search controller executes the routing method 400 of FIG. 4. At this point, the search controller 110 decides to execute a query processor “Thesaurus” 504. When the query processor 504 has finished its execution, control returns to the search controller 110 and the search controller executes the routing method 400 of FIG. 4. Thereafter, the search controller 110 decides to execute the “Stemmer” 506. When the stemmer has finished its execution, the search controller the search controller 110 executes the routing method 400 of FIG. 4, and determines that there are no more query processors to execute and then continues to the data collecting stage, where any data requests generated by the foregoing query processors 502, 504, 506 are sent to designated data collectors 116 as depicted in FIG. 1. Each query processor 502, 504, 506 processes the search query object 104 and runs in isolation of the other query processors, with no special options or instructions. For example, the thesaurus 504 may create a new data request for each synonym of query terms in search query object 104, and the stemmer 506 may then modify particular keys in the new data requests. However, the search system 100 accounts for certain situations where the foregoing routing behavior (described with FIGS. 4, 5A) is inadequate or undesirable. For example, perhaps not all the data requests generated by the thesaurus 504 should be processed by the stemmer 506, or perhaps the thesaurus 504 needs to be sure the search terms in the search query object are spelled correctly by executing a spell-checker query processor (not shown) before the stemmer query processor 506 is executed. The routing method 400 does not permit one module to directly call another module, or to influence the options that control how a module is run, i.e., specifying which data requests a module should process. Such fine-grained routing control cannot be achieved when each module finishes and returns control to the search controller 110, which then executes the routing method of FIG. 4 in order to decide the next module to execute. Thus, the search system 100 also enables local routing as particularly described below in FIG. 5B.

FIG. 5B depicts an exemplary representation of local routing according to the present invention. More specifically, local routing enables a module (i.e., query processor or result processor) to control the context with which a locally routed sub-module is called. The local routing enables a module to directly control the flow of objects through the query processor pool 106 and the result processor pool 120, rather than rely on the search controller 110 to control the flow of objects. In effect, the search system 100 temporarily cedes routing control to a module that employs “local routing.” Local routing uses method 400 of FIG. 4, except instead of using INQ_ROUTE and INQ_PATH, a local INQ_ROUTE and local INQ_PATH are specified by the module performing local routing. However, the local INQ_ROUTE is entirely unrelated to any original INQ_ROUTE for current object. In addition, since the module executing local routing in effect has control of the search system 100, it can also specify options or a specific set of data requests to be processed by the modules to which the data requests are locally routed to by the module executing local routing. As depicted in FIG. 5B, instead of the search controller 100 receiving control after each module finishes its execution, the query processor 502 uses local routing to first locally execute query processor 504 (i.e., thesaurus query processor), and then to locally execute query processor 506 (i.e., stemmer query processor). Because module 502 is in control of the local routing, it can specify that only some of the data requests are to be processed by the stemmer query processor 506. This is accomplished by calling the stemmer 506 with special options. That is, a module normally executes by examining and processing the search query object 104. When performing local routing, the module requesting a local route can make temporary modifications to the search query object 104, which is only used for the local routing. For example, the thesaurus 504 may read a key called NUM_SYNONYMS. When performing the local routing, the module calling the thesaurus 504 (i.e., my query processor 502) may temporarily set NUM_SYNONYMS to a different value, only used for the local routing. A module may also specify which data requests should be processed by the modules on the local route. Normally, when the stemmer 506 is executed, it processes all data requests, however if the query processor 502 calls the stemmer 506 using local routing, the query processor 502 can specify that a subset of all the data requests that should be processed. In order to be effective, a module (i.e., query processor, result processor), which uses local routing must also have certain knowledge about what other modules are usable by the search system 100. With this information a module can route objects directly to the desired modules, and directly manipulate the output from those modules, with complete control. This permits a module to act as intelligent processor and router, over and above the routing described with reference to FIGS. 4 and 5A.

While the invention has been particularly shown and described with regard to a preferred embodiment thereof, it will be understood by those skilled in the art that the foregoing and other changes in form and details may be made therein without departing from the spirit and scope of the invention.

What is claimed is:

1. A computer-implemented method for searching information in a search system having a plurality of resources and production rules for using, ordering and/or manipulating the resources, comprising:
augmenting the system's production rules based on a search strategy; and
dynamically determining at run-time the selection or order of said resources according to the production rules along with the augmented production rules.

2. The method of claim 1, wherein the augmenting the system's production rules comprises placing additional constraints on the production rules at run-time.

3. The method of claim 1, wherein the augmenting the system's production rules comprises nullifying one or more of the production rules at run-time.

4. The method of claim 1, further comprising specifying the search strategy during run-time.

5. The method of claim 1, wherein the search strategy is specified by a user.

6. The method of claim 1, wherein the search strategy is hard-coded.

7. The method of claim 1, further comprising executing the search strategy over a plurality of search passes over the resources.

8. The method of claim 7, wherein the search strategy of a search pass is modified by a prior search pass.

9. The method of claim 1, wherein the search strategy includes conditional operators that are evaluated during the search.

10. The method of claim 1, wherein one of the resource includes one of query processing resource, result processing resource and data source.

11. The method of claim 1, wherein the dynamic determining is controlled in accordance with the search strategy and a system state.

12. The method of claim 11, wherein the system state comprises a query.

13. The method of claim 11, wherein the system state comprises one or more messages passed among the resources.

14. The method of claim 7, further comprising modifying a query message received from one of the resources during one of said search passes for use in a subsequent pass.

15. The method of claim 14, wherein the modifying further comprises adding, deleting or changing of one or more keys in the query message.

16. The method of claim 7, further comprising modifying a data request received from one of the resources during one of said search passes for use in a subsequent pass.

17. The method of claim 16, wherein the modifying further comprises adding, deleting or changing one or more keys in the query message.

18. The method of claim 7, further comprising adding a data request directed at one of the resources during one of said search passes for use in a subsequent pass.

19. The method of claim 7, further comprising directing a query message at one of the resources over a route and altering the route during one of said search passes for use in a subsequent pass.

20. The method of claim 7, further comprising locally routing a message received from one of the resources during one of said search passes for use in a subsequent pass.

22. The method of claim 7, further comprising answering or generating one or more control messages received from one of the resources during one of said search passes for use in a subsequent pass.

23. The method of claim 7, further comprising updating a next pass condition received from one of the resources during one of said search passes for use in a subsequent pass.

24. The method of claim 1, further comprising optimizing a search result given the strategy and the production rules.

25. A system for searching information in a search system having a plurality of resources and production rules for using, ordering and/or manipulating those resources, comprising:
means for augmenting the system's production rules based on a search strategy; and
means for dynamically determining at run-time the selection or order of said resources according to said production rules along with the augmented production rules.

26. A computer-implemented method for searching information, comprising:
receiving a search strategy, the search strategy at least partially specifying at least one of the following: one or more search resources, interactions between search resources and conditions for the interactions;
generating a search query object having a specified route listing a plurality of query processors to operate on the search query object, the route being influenced by the search strategy;
executing the plurality of query processors according to the specified route for receiving and processing the search query object;
generating at each of the query processors zero or more data request objects based on the search query object and one or more data request objects generated by one or more previously executed query processors; and
converting each data request object to a request associated with an outside data source that performs a search according to the converted request.

27. A search system for performing a search over a plurality of data sources via one or more search passes, the system comprising:
a search controller for: i) transmitting a search query object having a specified route which lists a plurality of query processors desired to be executed, the route being influenced by a search strategy; ii) receiving data request objects from the plurality of executed query processors and transmitting the data request objects to a plurality of data collectors, each data request object being transmitted to associated data collectors, iii) receiving result objects associated with the data requests from the data collectors, and iv) transmitting the result objects to a user interface for display;
the plurality of query processors being executed according to the specified route to receive and process the search query object, each of the query processors enabled to generate a data request object based on the search query object and one or more data request objects generated by one or more previously executed query processors; and
each of the plurality of data collectors enabled to convert a data request object received from the search controller to a request associated with an outside data source that performs a search according to the converted request, and each data collector enabled to convert a result of the search transmitted from the outside data source to a result object.

28. A computer-implemented method for searching information in a search system having a plurality of resources and production rules for searching the resources, the search system having a default resource selection policy, the method comprising:
receiving a search strategy, the search strategy modifying the default resource selection policy during run-time;
augmenting the system's production rules based on the search strategy; and
dynamically determining at run-time the selection or order of said resources according to the production rules along with the augmented production rules.

29. A computer program product, tangibly stored on a computer-readable medium, for searching information in a search system having a plurality of resources and production rules for using the resources, the product comprising instructions operable to cause a programmable processor to:
augment the system's production rules based on a search strategy; and
dynamically determine at run-time the selection or order of said resources according to the production rules along with the augmented production rules.

30. The computer program product of claim 29, wherein the augment instructions comprises instructions to place additional constraints on the production rules at run-time.

31. The computer program product of claim 29, wherein the augment instructions comprises instructions to nullify one or more of the production rules at run-time.

32. The computer program product of claim 29, further comprising instructions to specify the search strategy during run-time.

33. The computer program product of claim 29, further comprising instructions to execute the search strategy over a plurality of search passes over the resources.

34. The computer program product of claim 33, wherein the search strategy of a search pass is modified by a prior search pass.

35. The computer program product of claim 29, wherein the dynamically determine instructions comprises instructions to control the search in accordance with the search strategy and a system state.

36. The method of claim 1, wherein said using includes providing a query to said one or more resources and receiving at least one result therefrom, wherein said ordering includes determining a sequence in which said resources are queried, and wherein said manipulating includes controlling the operation of said one more resources.
